(19) United States
(12) Patent Application Publication
(10) Pub. No.: US 2010/0042442 A1
(43) Pub. Date: Feb. 18, 2010

(54) Home Value Estimator

(75) Inventors: Esin Seitomer, Cranbury, NJ (US); Tim Arone, Highland Mills, NY (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: American International Group, Inc., New York, NY (US)

(21) Appl. No.: 12/191,787

(22) Filed: Aug. 14, 2008

(51) Int. Cl. G06Q 40/00; G06F 17/30

(52) U.S. Cl. 705/4; 707/200; 707/E17.005

(57) ABSTRACT

A home value estimator software application and related method assist a broker to systematically and accurately estimate the value of a customer's home. Another aspect of the disclosure relates to a heuristic research methodology that can be used to determine values of different characteristics of a home to estimate the value of the customer's home. Further, the values are categorized into different levels using other heuristic methods and then stored in at least one matrix in a database. The software application accesses the values based on user input data to calculate an estimate of the value of the customer's home. Thus, the estimate more accurately reflects the appraised value of the home than the prior art. Consequently, an insurance company may quote an initial premium and insurance coverage of home insurance product to a customer that requires less or nor adjustment after a home inspector appraises the home.

### FIELD OF THE INVENTION

The invention relates generally to systems and methods for estimating the value of a residential property and its contents, and more particularly, to systems and methods for estimating the value of a residential property and its contents to provide an initial insurance premium quote for insurance coverage for a home insurance product.

### BACKGROUND OF THE INVENTION

An insurance customer obtains typically home insurance (including condo/co-op insurance) from an insurance broker. The customer usually requests an initial quote of the insurance premium and coverage for the home insurance product from the broker. Before providing such an initial quote, the broker and insurance company require an estimate of the value of the customer's home. The broker often subjectively estimates the value of a customer's home and forwards the estimate to an insurance company. Thereafter, the insurance company returns an initial quote of the premium for an insurance policy for coverage based on the broker's estimate. After the customer pays the initial premium for the home insurance product, the insurance company dispatches a home inspector to the customer's home to appraise the value of the home. After the appraisal, the home inspector provides an inspection report to the insurance company's underwriters. The insurance company then adjusts the initial premium and insurance coverage according to the appraisal value of the home in the inspection report.

Frequently, the broker's estimate of the value of the home varies significantly from the appraisal value such that the customer's actual coverage and actual premium payment differ from the initial premium and coverage. In many cases, a home inspector finds the appraisal value of the home to be higher than the broker's estimate. Consequently, the insurance company increases the insurance premium and coverage. Although the customer pays for insurance coverage that reflects more closely the value of the insured property, the higher premium can lead to customer dissatisfaction.

Further, due to limited inspection teams, an insurance company can take several months to dispatch an inspection team to appraise a home and adjust the customer's premium and coverage. This time delay may diminish the likelihood the customer will purchase the insurance policy and/or decrease the customer's satisfaction concerning the purchase. In addition, the insurance company loses potential revenue during the time between the payment of the initial premium and the payment of the adjusted premium. That is, instead of receiving a higher initial premium based on an estimate that is close to the home appraisal value, the insurance company receives a lower initial premium based on the broker's subjective estimate that can result in a significant loss of revenue.

### BRIEF SUMMARY OF THE INVENTION

A home value estimator software application and related method assist a broker to systematically and accurately estimate the value of a customer's home. Another aspect of the disclosure relates to a heuristic research methodology that can be used to determine values of different characteristics of a home that are used to estimate the value of the customer's home. Two types of characteristics are home renovations and contents. Home renovations include the additions and alterations that have been made to the home since it was originally constructed. Home contents include home furnishings and the home residents' wardrobes. The heuristic methodology includes researching different types of home renovations (e.g., additions and alterations, etc.) and home contents (e.g., wardrobe, furnishings, etc.) based on their quantity and quality. Further, home renovation and home contents values are categorized into different levels using other heuristic methods to construct tables and matrices that are then stored in a database. The software application accesses the values for home renovations and contents based on the data entered by the user (e.g., broker) into the software application to calculate an estimate of the value of a customer's home. Thus, the estimate provided by the software application more accurately reflects the appraised value of the home than the prior art. Consequently, an insurance company may quote an initial premium and insurance coverage of a home insurance product to a customer that requires less or no adjustment after a home inspector appraises the home. Persons skilled in the art would recognize that the “value” of the home can also be called the “Total Replacement Cost” or “TRC” within the insurance industry. Hereafter the terms, “total replacement cost”, “TRC”, and “replacement cost” may used interchangeably with the term “value” in the context with the value of a home or its characteristics.

Another aspect of the disclosure relates to a method for calculating an estimated replacement cost of a home to provide initial insurance coverage for the home comprising receiving a request to access a home value estimator software application from a user and displaying a user interface of the home value estimator software application across a communication network to the user. The method further comprises receiving data pertaining to different characteristics of a customer's home from the user interface and accessing replacement costs of the different characteristics of the customer's home from at least one matrix stored in a replacement cost database based on a set of criteria. In addition, the method further comprises calculating an estimated replacement cost of the customer's home from the replacement costs of the different characteristics of the customer's home and generating an initial insurance premium and the initial insurance coverage using the home value estimator software application for the user.

Another aspect of the disclosure relates to a system for calculating an estimated a replacement cost of a home to provide an initial insurance coverage for the home, comprising a user interface responsive to user input, wherein the user interface transmits and receives data pertaining to different characteristics of a customer's home between a user and a home value estimator software application. The system further comprises of a replacement cost database capable of storing at least one matrix containing replacement cost data of different characteristics of the home and a server capable of transmitting and receiving data pertaining to the different characteristics of the customer's home and replacement costs of said characteristics of the customer's home, over the communication network. In addition, the system further comprises of the home value estimator software application, running on the server that calculates the replacement cost of the customer's home by determining replacement costs for individual characteristics associated with the home and then summing each of the individual characteristic replacements costs.

A novel method according to the invention includes the step of collecting replacement cost data for different characteristics of the home using a heuristic research methodology and storing the replacement cost data in a research database. The method further comprises analyzing the replacement cost data for the different characteristics of the home using analytical software tools and organizing replacement costs of different characteristics of the home into a set of categories based on a set of criteria using a heuristic categorizing methodology. In addition, the method further comprises of storing the set of categories of replacement costs for different characteristics of the home in at least one matrix and accessing a replacement cost from at least one matrix stored in the replacement cost database by a home value estimator software application. The method further comprises of estimating a total replacement cost of the home by adding each replacement cost of each different characteristics that is applicable to the home.

### BRIEF DESCRIPTION OF THE SEVERAL VIEWS OF THE DRAWINGS

FIG. 1 is a general architectural overview of an embodiment of a system for estimating the replacement cost of a residential property and its contents for securing insurance coverage of the same.

FIG. 2 is a flow diagram that illustrates an embodiment of a method for researching and analyzing the values for different home renovations and different home contents and categorizing the values into a set of tables or matrices to be used to estimate a replacement cost of a home.

FIG. 3 is a flow diagram that illustrates a set of exemplary steps performed by an exemplary software application to estimate a replacement cost for a home.

FIGS. 4-8 are exemplary user interfaces of an exemplary home value estimator software application, which is suitable for use in a system for estimating the replacement cost of a residential property and its contents for securing insurance coverage of the same.

FIG. 9 is a flow diagram that illustrates an exemplary method of calculating a premium and an insurance coverage for a home insurance product.

### DETAILED DESCRIPTION OF EMBODIMENTS OF THE INVENTION

A software application according to the invention assists a broker to generate an estimate of the TRC of a customer's residential property and its contents based on a systematic analysis of the characteristics of the home so that the insurance company accurately quotes an initial premium for insurance coverage to the customer. A home can be a condominium, co-operative residence, single family home or any other residential property. A heuristic research methodology can be used to determine values of different characteristics of a home that are used to estimate its value. Two types of characteristics are home renovations and contents. Home renovations can include the additions and alterations that have been made to the home since it was originally constructed. Home contents can include home furnishings and the home residents' wardrobes. The heuristic methodology includes researching different types of home renovations (e.g., additions and alterations, etc.) and home contents (e.g., wardrobe, furnishings, etc.) based on their quantity and quality. Further, home renovation and home contents values are categorized into different levels using other heuristic methods to construct tables and matrices that are then stored in a database. The software application accesses the values for home renovations and contents based on the data entered by the user (e.g., broker) into the software application to calculate an estimate of the TRC of a customer's home.

The heuristics methodology determines the replacement cost of the home renovations and home contents by their quality and quantity. The methodology captures the replacement cost of the physical attributes of the home by assessing the replacement cost of typical home renovations. Home renovations can be conducted on the home as a whole or in an individual room. The quantity of the home renovation can be expressed by the square footage of the home or the room. Quality of the renovations includes the cost of building materials and labor to construct the renovations. The methodology also takes into account the year when the renovation was performed. If no renovations have been done to the home since it was first built, then the methodology determines the replacement cost of the physical attributes of the home by the square footage of the home and the quality of its building materials and workmanship from the time it was originally constructed.

In addition to the home renovations, the methodology determines the replacement cost of typical home contents. The quantity of home contents may be estimated using the square footage of the home or room. Analyzing insurance industry data indicates that the larger the home or room the more contents (e.g., home furnishings and clothing wardrobe) it contains. The methodology includes obtaining data regarding the replacement cost of popular home furnishings and clothing manufacturers to determine the overall replacement cost of typical home contents.

Once the methodology determines the replacement cost of typical home renovations and home contents, it categorizes them into different levels within a table or matrix using heuristics and stores them into a database. Thereafter, a broker enters the quantity and quality of the customer's home renovations and contents into the software application. The software application accesses the appropriate replacement cost from the table or matrix for the customer's home renovations and contents database based on the data entered by broker.

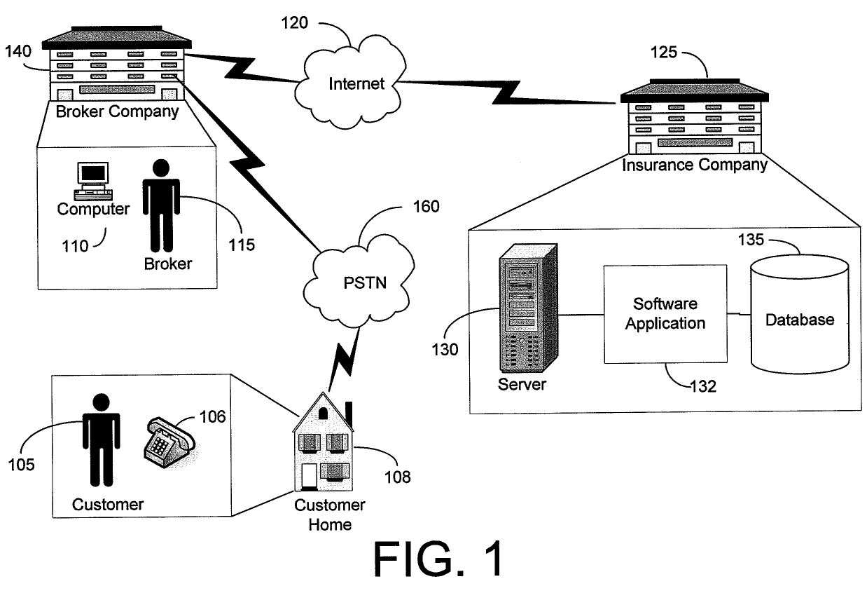

FIG. 1 is a general architectural overview of an embodiment of a system that estimates a TRC of a customer's home 108 for a home insurance product. An insurance customer 105 can request home insurance from an insurance broker (115, 140). A broker can interview the customer 105 to gather any necessary personal information and data pertaining to the different characteristics of the customer's home. This can include the quantity and quality of the home renovations and contents. Subsequently, a broker 115 can access from his computer 110 across the Internet 120 a home value estimator software application 132 residing at an insurance company 125 to enter the customer data. The software application 132 can be implemented by a server 130 located on the insurance company premises 125. In addition, the application 132 stores or accesses information pertaining to different characteristics of a home from the tables or matrices stored in the database 135. In other embodiments, at least one of application 132 and the database 135 can be stored on portable storage media (DVD, CD-ROM, etc.) or on the broker's computer 110.

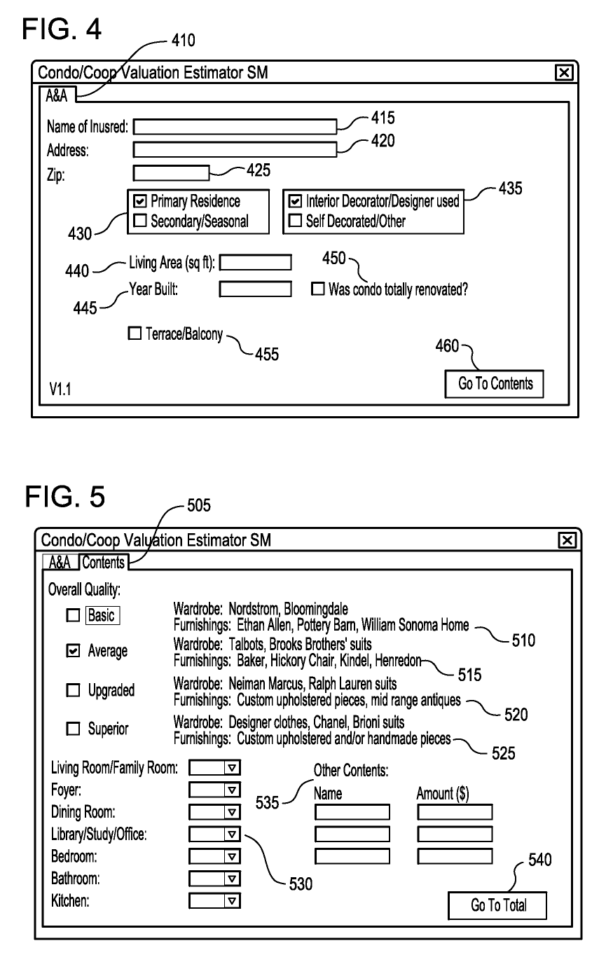

In the embodiment shown in FIG. 1, the broker 115 gathers data from a customer 105 from conversations over the telephone (106, 112) across a public switched telephone network (PSTN) 160. The broker enters this information into the software application 132 using a user interface presented on his computer 110. The software application 132 provides an estimate TRC of the customer's home 108 by accessing the replacement cost of different characteristics, such as the renovations and contents of the home from the tables and matrices stored in the database 135. The software application further accesses the values based on the quantity and quality of the customer's home renovations and the contents entered by the broker 115. The estimate calculated by the software application approximates the appraised TRC of the home because it is based on the quantity and quality of different characteristics of the home. The home value estimator software application 132 can have other features similar to the exemplary software application described below in connection with the user interfaces shown in FIGS. 4-8. Details of the calculating the estimate TRC of the home are described below.

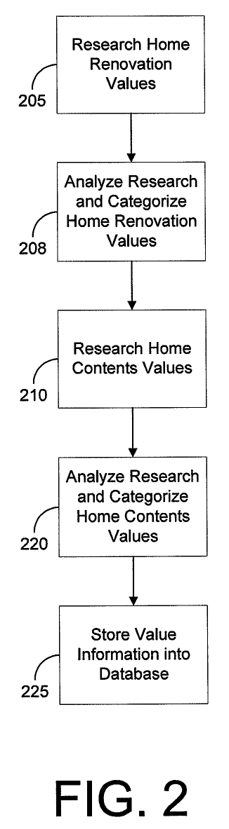

FIG. 2 is a flow diagram that illustrates an embodiment of a method for researching and analyzing the values for different home renovations and different home contents and categorizing the values into tables and matrices based on quantity and quality to be used to estimate a TRC of a home for a home insurance product. Several characteristics, such as home renovations and home contents affect the estimate. Further, home renovations can include additions and alterations (A&A) to a home.

At a step 205, the insurance company determines the replacement cost of different home renovations using a heuristic research methodology. The methodology includes the insurance company gathering data from contractors, home inspection teams, and claim adjusters to determine the cost of labor and building materials that are used in typical home renovations in the same or similar geographical area as the home under evaluation. In addition, the insurance company gathers data from building material sellers, such as price lists and invoices, to determine the costs of different building materials. At a step 208, after researching and gathering all the data relevant to valuing typical home renovations, the insurance company analyzes and distills the data to provide a TRC of the home renovations based on the square footage of the home. This involves analyzing historical data such as past insurance claims submitted by homeowners, home inspection reports, claim adjustment reports, contractor agreements, price lists, invoices, and other data. Software applications may be used in this methodology to quickly and efficiently analyze the large number of reports, claims, invoices, etc. and to calculate the replacements costs of typical renovations.

Further, the analysis takes into account the quality of the renovations (building materials, skilled labor, etc.) such that the insurance company categorizes the replacement cost of home renovations into different levels of quality. The category levels can be based on quantity and/or quality of the home renovations. The categories of values for home renovations are stored in tables or matrices, as shown in Table 1-7, as part of a database, for later access by a home value estimator software application.

Exemplary renovation replacement cost levels can be designated as Excellent, Above Average, and Average. The Excellent level is designated by home renovations that are constructed using superior building materials and high-skilled labor. Similarly, the insurance company can designate home renovations as Above Average and Average if building materials and skilled labor used in the construction are above average and average, respectively. In addition, values for home renovations can be adjusted for certain additions such as, but not limited to, terraces, balconies, decks, patios, porches, gardens, or garages.

Table 1 shows exemplary list of different values of home renovations expressed as replacement cost per square foot and based on the date and quality of the renovation. The information listed in Table 1 is stored in the database. Table 1 shows exemplary values as established by an insurance company for various categories including home renovations, based on square footage, in three time eras (Pre-1900, 1900-1944, and 1945-Present) and in three quality levels within each time era (Excellent, Above Average, Average). For example, Table 1 shows that Excellent quality of home renovations made before the year 1900 have a replacement cost per square foot of $680, Above Average quality of home renovations made before the year 1900 have a replacement cost per square foot of $425, and Average quality of home renovations made before the year 1900 have a replacement cost per square foot of $350.

TABLE 1
RENOVATIONS VALUES OF A HOME

| | Replacement Cost Per Square |
|---|---|
| Quality | Foot |
| | Date of Last Renovation |
| | Pre-1900 |
| Excellent | $680 |
| Above Average | $425 |
| Average | $350 |
| | Date of Last Renovation |
| | 1900-1944 |
| Excellent | $600 |
| Above Average | $375 |
| Average | $320 |
| | Date of Last Renovation |
| | 1945-present |
| Excellent | $500 |
| Above Average | $350 |
| Average | $300 |

The data in Table 1 is updated periodically (monthly, quarterly, annually, etc.) as additional data, such as submitted claims, home inspection reports, claim adjustment reports, invoices, price lists, etc. are gathered and analyzed as part of the heuristics methodology. Maintaining the tables and matrices that contain the values of home characteristics help provide an accurate TRC.

In addition to the quality of home renovations, an insurance company may use an accurate estimate of the quality of the home contents as another characteristic in valuing the home. Thus, the insurance company determines the replacement costs of different types of home contents using heuristic methods at a step 210. Contents of a home include, but are not limited to, a home furnishings and the residents' clothing wardrobe. The replacement cost of home contents can be based on quantity and quality. The square footage of the home or room and the methodology disclosed herein determine the quantity of different types of wardrobe and home furnishing items. An insurance company determines the quality of such items by researching the product lines of different retailers, gathering this data and storing it in a database. At a step 220, the insurance company may use a software application to analyze the home contents data and then categorize the values of the different types of home contents different levels such as Basic, Average, Upgraded, and Superior, and store them in tables or matrices as shown in Tables 2-7. Similar to the home renovations, the category levels can be based on the quantity and quality of the home contents. Basic quality of contents can be those that are purchased from discount retailers. Average quality of contents can be those that are purchased from retailers that offer generic products. Upgraded quality of contents can be those that are purchased from retailers that offer name-brand clothes and mid-range antique furnishings. Superior quality of contents can be those that are purchased from retailers that offer designer clothes and handmade furnishings.

Table 2-4 illustrate exemplary replacement cost levels for home furnishings based on each type of room in a home. As part of the heuristic methodology, the insurance company gathers and stores submitted claims, home inspection reports, claim adjustments reports, and retailers' price lists. Software applications may be used in this methodology to quickly and efficiently analyze the large number of reports, claims, price lists, etc. and to calculate the replacements costs of typical renovations. After analyzing this research, the insurance company categorizes and lists the data in tables and matrices similar to Tables 2-4. Tables 2-4 show different sizes of rooms in a home, and the type and quantity of home contents found in such a room. Further, Tables 2-4 shows the replacement cost of different quality of home contents. For example, the methodology indicates that a home with a small living room (120 square feet) contains one upholstered loveseat, one case furniture, four paintings, three lamps, and forty books. Further, analysis of the quality of different home contents shows that a Basic, Upgraded, and Superior quality of upholstered loveseat has a replacement cost of $4,000, $8,000, and $16,000, respectively. Similarly, Table 2 lists the replacement cost of each additional piece of home furnishing for a small living room based on the three categories of quality, Basic, Upgraded, and Superior. Thus, adding the replacement cost of each home furnishing provides a total replacement cost of a small living room based on the quality of the home furnishings. That is, a small living room with Basic, Upgraded, and Superior home furnishings, has a replacement cost of $23,000, $53,500, and $103,000, respectively.

TABLE 2

| | Quantity | | | | | | |
|---|---|---|---|---|---|---|---|
| | Small | Med | Large | X-Large | Quality | | |
| | 120 sqft | 200 sqft | 450 sqft | 600+ sqft | Basic | Upgraded | Superior |
| Living Room | | | | | | | |
| Upholstered Sofas | 0 | 2 | 2 | 2 | $5,000 | $10,000 | $20,000 |
| Upholstered Loveseats | 1 | 1 | 0 | 2 | $4,000 | $8,000 | $16,000 |
| Upholstered Chairs | 0 | 2 | 3 | 4 | $2,500 | $5,000 | $10,000 |
| Side Chairs | 0 | 1 | 6 | 2 | $1,000 | $2,500 | $5,000 |
| Throw Pillows | 0 | 8 | 12 | 12 | $300 | $500 | $500 |
| Occasional Table | 0 | 5 | 7 | 8 | $3,000 | $7,500 | $15,000 |
| Case Furniture | 1 | 1 | 0 | 3 | $10,000 | $20,000 | $30,000 |
| Paintings, Prints, Mirrors | 4 | 11 | 7 | 9 | $1,000 | $3,000 | $7,500 |
| Lamps | 3 | 3 | 7 | 5 | $1,000 | $2,500 | $5,000 |
| Books | 40 | 75 | 510 | 300 | $50 | $150 | $300 |
| Benches/Ottomans | 0 | 2 | 1 | 2 | $2,000 | $6,000 | $12,000 |
| Accessories | 0 | 15 | 95 | 40 | $200 | $400 | $300 |
| Foyer | | | | | | | |
| Table(s) | 1 | 2 | 1 | 1 | $1,500 | $5,000 | $10,000 |
| Upholstered Chairs | 1 | 0 | 1 | 2 | $2,500 | $5,000 | $10,000 |
| Lamps | 1 | 1 | 2 | 2 | $500 | $1,500 | $4,000 |
| Side Chairs | 2 | 0 | 2 | 2 | $1,000 | $2,500 | $5,000 |
| Accessories | 4 | 7 | 10 | 12 | $300 | $500 | $750 |
| Dining Room | | | | | | | |
| Table | 1 | 1 | 1 | 1 | $5,000 | $10,000 | $20,000 |
| Chairs | 6 | 5 | 11 | 12 | $1,200 | $3,500 | $5,000 |
| China | 24 | 24 | 24 | 24 | $400 | $750 | $1,500 |
| Crystal | 60 | 60 | 60 | 60 | $80 | $150 | $300 |
| Misc. Serving Pieces | 1 | 1 | 1 | 1 | $4,000 | $8,000 | $12,000 |
| Linens-Tablecloths | 4 | 8 | 10 | 12 | $250 | $500 | $1,500 |
| Linens-Napkins | 48 | 96 | 120 | 144 | $25 | $50 | $75 |
| Linens-Placemats | 12 | 24 | 24 | 48 | $50 | $75 | $125 |
| Sideboards, Breakfronts, | 1 | 1 | 2 | 3 | $5,000 | $15,000 | $30,000 |
| China Closet | | | | | | | |
| Paintings, Prints, Mirrors | 6 | 8 | 8 | 10 | $1,000 | $3,000 | $7,500 |
| Accessories | 10 | 14 | 18 | 20 | $400 | $800 | $1,200 |
| Library/Den | | | | | | | |
| Upholstered Sofas | 1 | 2 | 2 | 2 | $5,000 | $10,000 | $20,000 |
| Upholstered Loveseats | 0 | 0 | 1 | 1 | $4,000 | $8,000 | $16,000 |
| Upholstered Chairs | 4 | 1 | 2 | 3 | $2,500 | $5,000 | $10,000 |
| Side Chairs | 1 | 1 | 2 | 2 | $1,000 | $2,500 | $5,000 |
| Throw Pillows | 6 | 8 | 10 | 12 | $300 | $500 | $750 |
| Occasional Table | 3 | 2 | 6 | 8 | $3,000 | $7,500 | $15,000 |
| Case Furniture | 0 | 2 | 2 | 2 | $10,000 | $20,000 | $30,000 |
| Paintings, Prints, Mirrors | 0 | 5 | 7 | 9 | $1,000 | $3,000 | $7,500 |
| Lamps | 4 | 4 | 4 | 5 | $1,000 | $2,500 | $5,000 |
| Books | 400 | 600 | 800 | 1200 | $75 | $150 | $300 |
| Benches/Ottomans | 2 | 1 | 2 | 2 | $2,000 | $6,000 | $12,000 |
| Accessories | 10 | 15 | 25 | 40 | $200 | $400 | $600 |
| TV/DVD/VCR | 1 | 1 | 1 | 1 | $1,000 | $3,000 | $5,000 |
| CD's/DVD's/Videos | 200 | 300 | 400 | 500 | $25 | $25 | $25 |
| Stereo System (not built-in) | 1 | 1 | 1 | 1 | $1,000 | $3,000 | $5,000 |
| Bedrooms | | | | | | | |
| Bed | 1 | 1 | 1 | 1 | $4,500 | $9,000 | $15,000 |
| Bed Linens | 5 | 5 | 5 | 5 | $350 | $750 | $1,200 |
| Pillows/Throw Pillows | 6 | 6 | 6 | 6 | $250 | $500 | $750 |
| Tables | 2 | 4 | 4 | 6 | $3,000 | $5,000 | $8,000 |
| Lamps | 2 | 3 | 4 | 5 | $1,000 | $2,500 | $5,000 |
| Upholstered Chairs | 1 | 1 | 2 | 2 | $2,500 | $5,000 | $10,000 |
| Upholstered Sofas | 0 | 0 | 1 | 1 | $5,000 | $10,000 | $20,000 |
| Upholstered Loveseats | 0 | 0 | 1 | 1 | $4,000 | $8,000 | $16,000 |
| Case Furniture | 1 | 2 | 2 | 2 | $7,000 | $20,000 | $30,000 |
| Paintings, Prints, Mirrors | 6 | 7 | 8 | 12 | $1,000 | $3,000 | $7,500 |
| Accessories | 10 | 12 | 14 | 16 | $200 | $400 | $600 |
| TV/DVD/VCR | 1 | 1 | 1 | 1 | $1,000 | $2,000 | $3,000 |

TABLE 3

| | Quantity | | | | | | |
|---|---|---|---|---|---|---|---|
| | Small | Med | Large | X-Large | Quality | | |
| Bathrooms | 75 sqft | 100 sqft | 150 sqft | 200+ sqft | Basic | Upgraded | Superior |
| Bath Linens | 10 | 10 | 10 | 10 | $100 | $300 | $500 |
| Cosmetics | 1 | 1 | 1 | 1 | $2,000 | $4,000 | $10,000 |
| Misc. | 1 | 1 | 1 | 1 | $500 | $1,500 | $3,000 |

TABLE 4

| | Quantity | | | | | | |
|---|---|---|---|---|---|---|---|
| | Small | Med | Large | X-Large | Quality | | |
| | 80 sqft | 130 sqft | 300 sqft | 400+ sqft | Basic | Upgraded | Superior |
| Kitchen | | | | | | | |
| Cookware | 15 | 20 | 25 | 30 | $200 | $250 | $300 |
| Flatware | 12 | 12 | 12 | 12 | $50 | $100 | $200 |
| Dinnerware | 12 | 12 | 12 | 12 | $200 | $300 | $400 |
| Dry Goods | 1 | 1 | 1 | 1 | $1,000 | $2,000 | $3,000 |
| Food/Wine/Liquor | 1 | 1 | 1 | 1 | $2,000 | $3,000 | $4,000 |
| Glassware | 60 | 60 | 60 | 60 | $40 | $70 | $100 |
| Small Appliances | 6 | 9 | 12 | 15 | $200 | $300 | $400 |
| Misc. inc. linens | 1 | 1 | 1 | 1 | $3,000 | $5,000 | $7,000 |
| Table | 1 | 1 | 1 | 1 | $2,000 | $3,000 | $5,000 |
| Chairs | 4 | 6 | 6 | 8 | $300 | $500 | $800 |
| TV | 1 | 1 | 1 | 1 | $500 | $1,000 | $1,500 |
| Misc. | | | | | | | |
| Luggage | 2 | 5 | 7 | 9 | $500 | $1,000 | $2,500 |
| Golf Clubs | 1 | 1 | 1 | 1 | $2,000 | $2,000 | $2,000 |
| Sports Equipment | 1 | 1 | 1 | 1 | $500 | $1,000 | $2,000 |

Tables 5 and 6 illustrate exemplary replacement cost levels for men's and women's wardrobe of home as a result of insurance company's heuristics methodology. Analyzing home inspection reports, claim adjustment reports, submitted claims, and price lists using software applications as part of the methodology shows that the quantity of clothes in a wardrobe depends on size of the clothing storage area (e.g. closet, small dressing room, medium dressing room, large dressing room, etc.). That is, the larger the wardrobe storage area in the home, then the larger the quantity of clothes (shirts, suits, pants, etc.). Further, Tables 5 and 6 show the replacement cost of each clothing item in a wardrobe as a function of its quality. The quality levels are designated as Basic, Customer, and Upscale. For example, each men's shirt that has Basic, Custom, or Upscale quality has a replacement cost of $750, $2,000, and $5,000, respectively. Further, Table 5 shows the replacement cost of a closet-sized men's wardrobe of Basic quality to be $39,000.

TABLE 5

| | Quantity | | | | | | |
|---|---|---|---|---|---|---|---|
| | | Sm. Dr. | Med. | Lg. Dr. | | | |
| | Closet | Rm. | Dr. Rm. | Rm. | Quality | | |
| Men's Wardrobe | (20-30 sqft) | (30-50 sqft) | (50-100 sqft) | (100+ sqft) | Basic | Custom | Upscale |
| Suits | 10 | 20 | 30 | 40 | $750 | $2,000 | $5,000 |
| Shirts | 20 | 40 | 60 | 80 | $100 | $250 | $500 |
| Sweaters | 15 | 25 | 35 | 45 | $150 | $300 | $500 |
| Shoes | 20 | 30 | 40 | 50 | $200 | $400 | $750 |
| Ties | 40 | 50 | 60 | 70 | $75 | $125 | $225 |
| Coats | 15 | 25 | 35 | 45 | $750 | $1,250 | $3,000 |
| Pants | 10 | 15 | 20 | 25 | $150 | $250 | $400 |
| Belts | 10 | 15 | 20 | 25 | $150 | $300 | $500 |
| T-Shirts | 30 | 40 | 50 | 60 | $25 | $30 | $40 |
| Golf Shirts | 20 | 30 | 40 | 50 | $100 | $150 | $200 |
| Button Downs | 20 | 30 | 40 | 50 | $75 | $100 | $150 |
| Shorts | 10 | 20 | 30 | 40 | $50 | $100 | $150 |
| Hats | 10 | 15 | 20 | 25 | $50 | $100 | $150 |
| Jeans | 5 | 10 | 15 | 20 | $50 | $100 | $200 |
| Casual Pants | 10 | 15 | 25 | 30 | $50 | $100 | $150 |

TABLE 6

| | Quantity | | | | | | |
|---|---|---|---|---|---|---|---|
| | | Sm. Dr. | Med. | Lg. Dr. | | | |
| Woman's | Closet | Rm. | Dr. Rm. | Rm. | Quality | | |
| Wardrobe | (20-30 sqft) | (30-50 sqft) | (50-100 sqft) | (100+ sqft) | Basic | Custom | Upscale |
| Suits | 7 | 15 | 25 | 30 | $500 | $1,500 | $4,500 |
| Blouses | 15 | 20 | 30 | 40 | $250 | $500 | $750 |
| Dresses | 15 | 25 | 35 | 45 | $350 | $750 | $1,250 |
| Gowns | 5 | 10 | 20 | 30 | $2,000 | $4,000 | $7,000 |
| Shoes | 30 | 50 | 70 | 100 | $150 | $500 | $1,000 |
| Handbags | 20 | 30 | 40 | 50 | $350 | $800 | $2,500 |
| Scarves | 15 | 25 | 35 | 45 | $150 | $250 | $400 |
| Belts | 10 | 20 | 30 | 40 | $100 | $300 | $500 |
| Dress Pants | 20 | 30 | 40 | 50 | $150 | $350 | $500 |
| Sweaters | 25 | 35 | 45 | 55 | $150 | $300 | $500 |
| Casual Pants | 15 | 30 | 40 | 50 | $75 | $150 | $300 |
| Hats | 10 | 15 | 20 | 25 | $250 | $450 | $650 |
| Underwear | 30 | 40 | 50 | 60 | $15 | $30 | $100 |
| Casual Shirts | 40 | 60 | 80 | 100 | $75 | $100 | $150 |
| Coats | 20 | 30 | 40 | 50 | $750 | $1,250 | $3,000 |
| Skirts | 30 | 40 | 50 | 75 | $150 | $350 | $500 |

The data in Tables 2-6 is updated periodically (monthly, quarterly, annually, etc.) as additional data, such as submitted claims, home inspection reports, claim adjustment reports, invoices, price lists, etc. are gathered and analyzed as part of the heuristics methodology. Maintaining the tables and matrices that contain the values of home characteristics help provide an accurate TRC.

The insurance company stores the category levels regarding the different values of home renovations and contents into tables and matrices, such as those shown in Tables 1-6, in a database for later access by a home value estimator software application as shown in step 225.

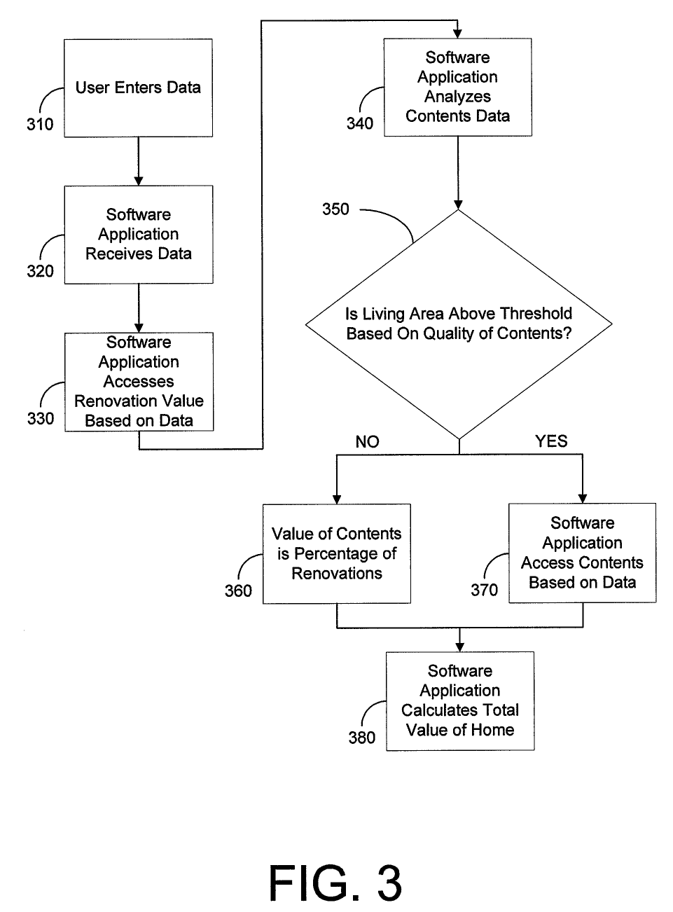

FIG. 3 is a flow diagram that illustrates an embodiment of a method for an exemplary software application to estimate a TRC for a home for a home insurance product. At a step 310, a user (e.g., broker) enters data pertaining to the different characteristics of the customer's home into the software application through a user interface. This data can include the quantity and quality of the home renovations and home contents. At a step 320, the software application receives the data from the user through the user interface and then, step 330, accesses the replacement cost of the customer's home renovation based on the data. Before accessing the value, the software application preferably analyzes the data to determine the quantity and quality of the home renovations. This includes analyzing the date of the renovation, the square footage of the home or room of the renovations, and the quality of the renovations as entered by the broker into the software application. The software application then selects the replacement cost for the home renovation from the appropriate category level from the tables and matrices stored in the database, and at a step 340, analyzes the home contents data entered by the broker.

At a decisional 350, the software application implements a rule to determine whether the living area (in square feet) is above a predetermined threshold based on the quality entered by the user. If the living area exceeds the threshold, the software application accesses the replacement cost of the contents from the tables or matrices stored in the database, similar to the values listed in Tables 2-6, based on the quality entered by the user at a step 370. However, if the living area is not above the threshold then, at a step 360, the software application selects the replacement cost of the contents as a percentage of the replacement cost of the renovations based on the quality of contents, as shown in Table 7. This rule, when implemented, tends to prevent the broker from overestimating the quality of the home contents. For example, the rule shown in decisional 350 prevents a broker from entering a high quality of home contents for a small sized home. For example, for Superior quality of home contents, the predetermined threshold for living area in decisional 350 is determined to be 2000 square feet. Thus, if the user enters Superior quality of contents for the home, but the home has less than 2000 square feet of living area, then the replacement cost of its contents is 50% of the replacement cost of its A&A as shown in Table 7. At a step 380, the software application calculates the replacement cost based on the renovation replacement cost and the contents value.

The software application may have an additional feature that allows a supervisor or administrator to configure the software application not to implement the rule shown in decisional 350 and to access replacement costs from Tables 2-6. This may be necessary in homes located in urban areas that have high costs of living. Homes in these areas may be small in terms of square footage but still have high quality of contents.

TABLE 7
DEFAULT VALUES OF THE QUALITY OF CONTENTS

| Quality | Percent of A&A |
|---|---|
| Superior | 50% |
| Upgraded | 40% |
| Average | 35% |
| Basic | 25% |

FIGS. 4-8 are exemplary user interfaces of a software application for estimating the TRC of a condominium or a co-operative residence. Using the software application, the insurance company provides a estimate of a home's TRC that accurately reflects to the appraised value by assessing the quantity and quality of the home renovations (e.g., additions and alterations ( A&A)) and the home contents (e.g., wardrobe and furnishings). Shown in FIG. 4 is a user interface 405 that allows a broker to enter several characteristics of a home. This includes entering the A&A information in data field (410) into the software application (e.g., spreadsheet software application). A broker enters the customer's name in a name field (415) and address in an address field (420) and a zip code field (425). Further, the broker enters whether the home is the customer's primary residence or secondary residence, and whether the home was professionally or self decorated, by clicking the respective checkboxes (430) and (435). The broker also enters the square footage of the condominium in data field (440), the year the condominium was built in data field (445), and whether the condominium was totally renovated by clicking the checkbox (450). In addition, the broker enters whether the condominium has a terrace or balcony by clicking the checkbox (455). All the information entered by the broker into the software application through the user interface shown in FIG. 4 is analyzed to determine the quantity and quality, and thus, the replacement cost of the A&A of the home. As mentioned previously, if no renovations, additions, or alterations were made to the home, then the broker enters the quantity and quality of the home as it was first built.

The software application accesses the replacement cost of different characteristics (e.g., date of renovation, quality of A&A, cost of building materials, cost of labor, etc.) of the A&A of the home from the tables and matrices stored in the database based on the customer's data entered by the broker. Subsequently, the software application uses the accessed values to estimate the TRC of the home. After entering all the A&A information, a broker clicks on a push button 460 to proceed to enter information pertaining to the quantity and quality of contents of the customer's home.

An insurance company provides a home estimate that is close to the appraised replacement cost by assessing the quality of the contents of the customer's home. Consequently, in FIG. 5, the user interface (505) allows the broker to enter the quantity and quality of the contents of the customer's home by clicking the appropriate checkbox (510, 515, 520, and 525) into the home value estimator software application. For example, in FIG. 5, a customer that shops at Bloomingdale's and Pottery Barn is considered to have a basic quality of wardrobe and furnishings (510) while a customer that shops at Brooks Brothers and Baker has an average quality of wardrobe and furnishings (515). In addition, exemplary Upgraded and Superior wardrobes and furnishings can be Ralph Lauren suits and mid-range antiques (520), and designer clothes and custom upholstered furniture (525), respectively. The broker also enters the number of each type of room in the home by selecting the appropriate number from the drop down menus (530) (e.g., number of bedrooms, bathrooms, family rooms, etc.). In addition, the broker enters additional contents in data fields (535), such as expensive jewelry or paintings that are kept in the home. The software application accesses the values for the home furnishings and clothing wardrobe of the home contents from the tables and matrices stored in the database based on the home's square footage, the number of rooms, and the quality of the home contents it receives from the broker across the user interface.

Subsequently, the software application calculates an estimated total replacement cost of the home based on the data accessed from Tables 1-7. A user instructs the software application to calculate the TRC of the home by clicking a push button (540). The TRC can be the initial insurance coverage and be used to calculate the initial premium for the home insurance product.

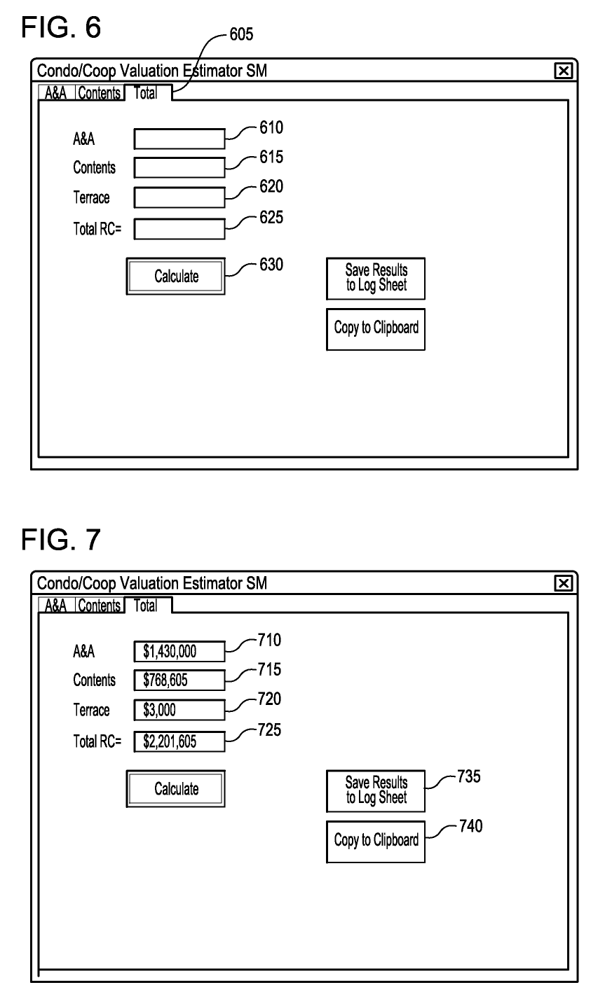

The user interface shown in FIG. 6 (605) displays empty data fields (610, 615, 620, and 625) for the values of the additions and alterations, the contents, the terrace, and the Total Replacement Cost for the home insurance product. The values are displayed after the broker clicks the Calculate push button (630).

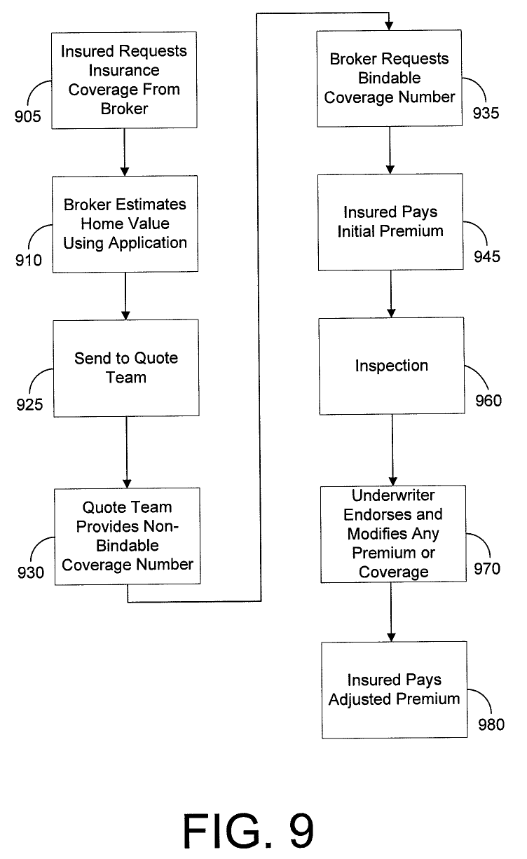

In FIG. 7, the user interface displays values of different characteristics of the home in data fields (710, 715, 720, and 725) after the user clicks the Calculate push button (630) in FIG. 6. This includes the replacement cost of the additions and alterations, the contents, the terrace, and the Total Replacement Cost. Once the values are calculated, the broker can save the result to a log sheet by clicking push button (735) or copy the result to the clipboard by clicking push button (740), which may be forwarded to the insurance company. The insurance company calculates the initial premium and initial coverage based on the Total Replacement Cost. Details for calculating the initial premium of the insurance policy are demonstrated when discussing FIG. 9, Example 1, and Example 2.

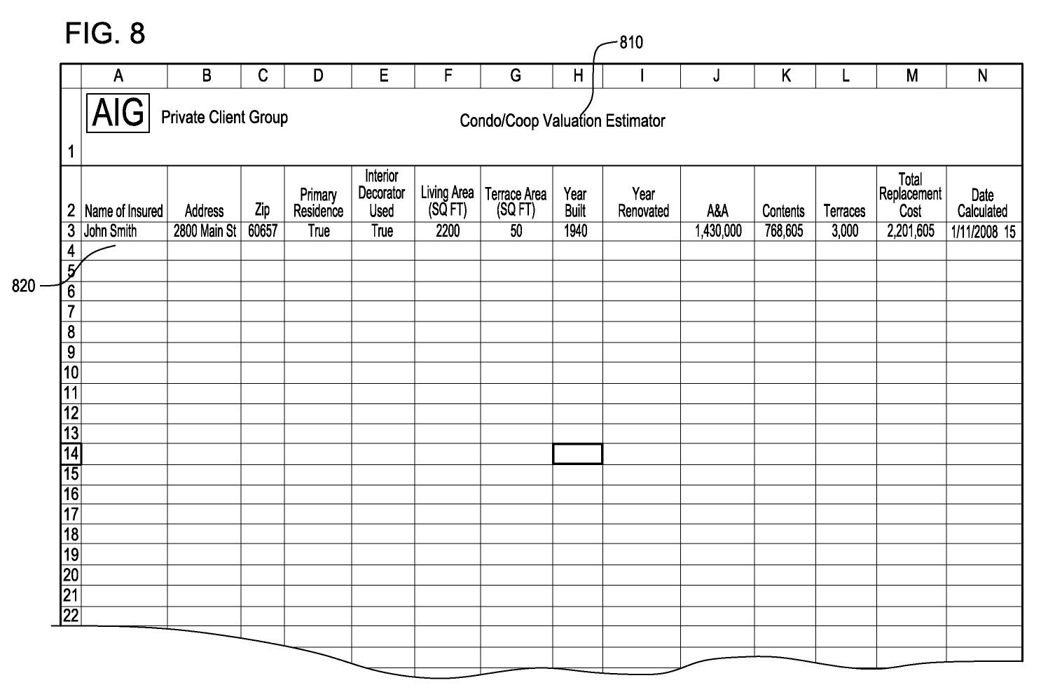

FIG. 8 is another exemplary user interface 810 of an aspect of the disclosure where the information gathered from the home value estimator application can be stored in a spreadsheet 820. In other embodiments, the information can be stored in a database such as one available via the Access software application commercially available from Microsoft Corp., for example, or any other suitable storage medium. Although the user of the software application in connection with the user interfaces shown in FIGS. 4-8 can be a broker, a user may also be a customer, insurance company personnel, or any other user needing assistance in calculating the TRC of a customer's home.

FIG. 9 is a flow diagram that illustrates another embodiment of a method for estimating the TRC of a home for a home insurance product. At a step 905, a customer requests home insurance coverage from a broker. At a step 910, the broker accesses the home value estimator software application over the Internet using a user interface. The broker enters the customer data regarding different characteristics of the home that include, but are not limited to, date of last renovation of the home, quantity and quality if the home renovations and home contents. Additional characteristics include whether the home includes any other additions and alterations such as a terrace, balcony, deck, patio, porch, or garage and the square footage thereof.

An alternative embodiment of the disclosure includes the user entering data for each room. That is, the user enters the date of the last renovation of each room in a home, the square footage thereof, the quality of the room renovations, and the quantity and quality of the contents of each room rather than providing such data for the home as a whole. By providing characteristic information for each room instead of the home as a whole, it allows an insurance company to accurately estimate the TRC of a home. An insurance company that has such an estimate provides an initial premium and initial insurance coverage that accurately reflects the adjusted premium and coverage determined after the home is appraised.

As part of the customer data, the broker enters the quantity and quality of building materials and labor used in the home renovations. Alternatively, the broker enters the retailer from which the customer purchased building materials and/or the construction company the customer hired to renovate the home. In addition, the broker enters the quantity and quality of home furnishings and the residents' wardrobe. The software application analyzes the entered customer data and selects appropriate replacement cost for the customer's home renovations and home contents from the database. Upon accessing the replacement cost of the home renovations and contents from the tables and matrices stored in the database, the software application estimates the customer's home TRC by adding the two values and generates a Total Replacement Cost (TRC) for the customer's home. The Total Replacement Cost of a home can be the upper limit of the insurance coverage of the home insurance product.

At a step 925, the broker sends the Total Replacement Cost to the insurance company quote team. The quote team analyzes the customer home information that includes the quantity and quality of the home's renovations and contents, and the Total Replacement Cost to provide a non-bindable premium and coverage number to the broker in a step 930. The non-bindable premium and coverage number is the initial premium and coverage of the insurance policy.

The insurance company determines the initial premium and coverage by reference to the loss event frequency rate for insuring a home. The loss event frequency rate includes events such as loss of home due to fire, natural disaster, or some other loss event in a particular geographic location over a time period (e.g. month, year, etc.). Also, as part of calculating the initial premium and coverage, the insurance company determines the Target Loss Ratio of the insurance product. The Target Loss Ratio (TLR) takes into account costs for overhead, commission to brokers, and profit margin. The insurance company calculates the initial premium of the insurance product by multiplying the total replacement cost of the home by the loss event frequency rate and then dividing by the Target Loss Ratio.

At a step 935, the broker requests a bindable coverage number from the insurance company. The insurance company makes an Inspection Request to dispatch a home inspector to the customer's home to appraise its value. Further, the insurance company prepares an insurance policy for the customer to the broker, which in turn is given to the customer. At a step 945, the customer pays the initial premium stated on the policy. At a step 960, the insurance company performs an inspection of the customer's home to appraise its value. Thereafter, an inspection report is generated and given to the underwriter. At a step 970, the underwriter evaluates the inspection report then endorses and, if necessary, adjusts the initial insurance premium and initial insurance coverage on the policy. At step 980, the customer pays the underwriter-adjusted premium on the policy.

The following examples further illustrate principles and features of estimating the TRC of a home thereby calculating the initial premium and coverage for a home insurance product but should not be construed as limiting in any way.

### EXAMPLE 1

Example 1 demonstrates the calculation of an initial premium for a home insurance product in keeping with the disclosed principles. A user enters the living area (in square feet), the date that a home was last renovated, and the quality of the renovations, into an exemplary user interface of the software application as shown in FIG. 4. The software application accesses a table from an electronic database, similar to Table 1, which lists the replacement cost per square foot that is based on the date of the home's last renovation and the quality of the renovations. Further, a user enters the quantity and quality of the home contents into an exemplary user interface of the software application as shown in FIG. 5. The software application accesses a table from an electronic database, similar to Tables 2-7 that lists the replacement cost of the home contents based on quantity and quality. Tables 1-7 can be constructed using the analytical software applications discussed when describing FIG. 2.

In Example 1, Table 8 lists the living area of a home to be 2000 square feet, the Date of Last Renovation to be 1895, and the quality to be Excellent. Using the tables and matrices described in connection with FIG. 2, a home last renovated in 1895 and in Excellent Condition, has a cost per square foot of $680 (See Table 1). The replacement cost of A&A is equal to the Living Area multiplied by the Cost per Foot. Therefore, in Example 1, the Cost of A&A is equal to $1,360,000. In addition, the home has a terrace having an area of 100 square feet. The replacement cost per foot for the terrace is equal to $50. Thus, the replacement cost of the entire terrace is equal to $500. Further, in Example 1, the quality of the contents of the home is rated as Superior. Using the analytical software applications discussed when describing FIG. 2, the replacement cost of the contents is found to be $680,000. Thus, the total replacement cost is calculated to be the sum of the replacement cost of A&A, the replacement cost of the terrace, and the replacement cost of the home's contents, which is equal to $2,040,500.

To calculate the premium of a policy, the insurance company determines a loss event frequency rate. In Example 1, the insurance company finds the loss event frequency rate (over a typical term for the insurance policy) for a home to be one out of ten thousand (0.0001). That is, an insurance company determines, on average, it pays out a claim only once when insuring ten thousand homes in a particular geographic area for the loss events included in the insurance policy over the term of the policy. The insurance company spreads the cost of the loss event across the ten thousand insurance policy holders. Therefore, the cost per policyholder is the total replacement cost multiplied by the loss event frequency rate (0.0001). Consequently, in Example 1, the cost per policyholder is $204.05. In addition, the insurance company selects a Target Loss Ratio (TLR) to take into account costs for overhead, commission to brokers, and profit margin. In this example, the insurance company selects a Target Loss Ratio of 50%. Thus, if the total replacement cost comprises 50% of the premium and if the overhead and broker commissions each account for 20%, then the insurance company's profit margin is 10% for the insurance policy in Example 1. The premium for the policy is therefore cost per policyholder divided by the Target Loss Ratio. Therefore, in Example 1, the premium is $204.05 divided by 50% resulting in a premium of $408.10.

TABLE 8
CALCULATIONS

| Living Area | 2000 sq ft |
|---|---|
| Date of Last Renovation | 1895 |
| Quality of A&A | Excellent |
| Living Area × Cost Per | 2000 × $680 |
| Square Foot | |
| Cost of A&A | $1,360,000 |
| Terrace Area × $50 | 100 × $50 |
| Cost of Terrace | $500 |
| Quality of Contents | Superior |
| Replacement Cost of | $680,000 |
| Contents | |
| Total Replacement Cost | $2,040,500 |
| Loss Event Frequency Rate | 1/10,000 |
| Cost Per Policy Holder | $204.05 |
| Target Loss Ratio | 50% |
| Premium | $408.10 |

### EXAMPLE 2

Example 2 demonstrates the calculation of an initial premium for a home insurance product in keeping with disclosed principles. In Example 2, the total replacement cost of a home is calculated based on the renovation and contents of each room separately rather than the renovation and contents of the home as a whole as was demonstrated in Example 1. Calculating an estimated TRC of a home based on the characteristics of each room of the home, rather than the home as a whole provides an estimate of the TRC of the home that tends to more accurately reflect to its appraised value. This in turn provides for an initial premium and initial insurance coverage that more accurately reflects to the adjusted premium and coverage.

A user enters into a software application the quantity and quality of each room renovations and contents. A software application accesses a table from an electronic database, similar to Table 9, which lists the replacement cost per square foot that is based on each room's date of last renovation, quality of the room renovations and contents. Further, the software application calculates the replacement cost per room, as shown in Table 10. Table 10 lists the square footage of the room, cost per square foot and the replacement cost of the room renovations, the replacement cost of the room contents, and the total replacement cost of the room. The cost per square foot of the renovations and the cost of the contents are found by using the tables and matrices that were described in connection with FIG. 2. The software application calculates the replacement cost of the room by multiplying the square footage to the cost per square foot of the room renovation, and then adding the replacement cost of the contents.

Table 11 lists the total replacement cost of the home, which is the sum of the replacement cost of each room in the home (See Table 10). In Example 2, the total replacement cost is equal to $1,861,500. Determining a loss event frequency rate of one out of ten thousand (same as in Example 1), the cost per policy is calculated to be $186.15. Thus, after selecting a Target Loss Ratio of 50% and dividing it by the cost per policy, the premium for the policy is calculated to be $372.30.

TABLE 9
ROOM CHARACTERISTICS

| | Square | Date of | Quality of | Quality of |
|---|---|---|---|---|
| Room | Footage | Renovation | Room | Contents |
| Living Room | 400 | 1920 | Excellent | Superior |
| Foyer | 80 | 1920 | Excellent | Average |
| Dining Room | 280 | 1920 | Excellent | Superior |
| Study | 140 | 2000 | Excellent | Average |
| Master | 360 | 2000 | Excellent | Superior |
| Bedroom | | | | |
| Guest | 180 | 2000 | Excellent | Average |
| Bedroom 1 | | | | |
| Guest | 160 | 2000 | Excellent | Average |
| Bedroom 2 | | | | |
| Master | 120 | 2000 | Excellent | Superior |
| Bathroom | | | | |
| Guest | 70 | 1920 | Excellent | Average |
| Bathroom | | | | |
| Kitchen | 160 | 2000 | Excellent | Superior |
| Family Room | 400 | 1920 | Excellent | Average |

TABLE 10

| | | | | Re- | |
|---|---|---|---|---|---|
| | | | Replacement | placement | Total |
| | | Cost | Cost of | Cost of | Replacement |
| | Square | Per | Room | Room | Cost of |
| Room | Footage | Sq. Ft. | Renovation | Contents | Room |
| Living | 400 | $600 | $240,000 | $120,000 | $360,000 |
| Room | | | | | |
| Foyer | 80 | $600 | $48,000 | $16,800 | $64,800 |
| Dining | 280 | $600 | 168,000 | $84,000 | $252,000 |
| Room | | | | | |
| Study | 140 | $500 | $70,000 | $24,500 | $94,500 |
| Master | 360 | $500 | $180,000 | $90,000 | $270,000 |
| Bedroom | | | | | |
| Guest | 180 | $500 | $90,000 | $31,500 | $121,500 |
| Bedroom 1 | | | | | |
| Guest | 160 | $500 | $80,000 | $28,000 | $108,000 |
| Bedroom 2 | | | | | |
| Master | 120 | $500 | $60,000 | $30,000 | $90,000 |
| Bathroom | | | | | |
| Guest | 70 | $600 | $42,000 | $14,700 | $56,700 |
| Bathroom | | | | | |
| Kitchen | 160 | $500 | $80,000 | $40,000 | $120,000 |
| Family | 400 | $600 | $240,000 | $84,000 | $324,000 |
| Room | | | | | |

TABLE 11
CALCULATIONS

| | |
|---|---|
| Total Replacement Cost of | $1,861,500 |
| Home | |
| Loss Event Frequency Rate | 1/10,000 |
| Cost per Policy | $186.15 |
| Target Loss Ratio | 50% |
| Premium | $372.30 |

Attached is an appendix that contains software code that implements an embodiment of the invention. Persons skilled in the art would recognize that software code is exemplary and does not limit or restrict the scope of the invention in any way. Further, persons skilled in the art would recognize that the software application can reside on a server but can also be but is not limited to a client-server application, a web based application, an Internet based application, an application that can be downloaded from the web or Internet, a Java applet that can be stored on a personal computer for the use by a broker, customer, or any other user in need of assistance in estimating the TRC of a home.

All references, including publications, patent applications, and patents cited herein are hereby incorporated by reference to the same extent as if each reference were individually and specifically indicated to be incorporated by reference and were set forth in their entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

```
APPENDIX

[symbol]

[symbol]

Option Explicit
Dim myRooms0(1 To 7) As Integer
Dim myRooms1(1 To 6) As Integer
Dim cost(1 To 9, 1 To 4) As Double
Private Sub chkAverage_Click( )
If (chkSuperior.Value = True) Or chkBasic.Value = True Or chkUpgraded = True Then
  chkSuperior.Value = False
  chkUpgraded.Value = False
  chkBasic.Value = False
  chkAverage.Value = True
End If
End Sub
Private Sub chkBasic_Click( )
  If (chkSuperior.Value = True) Or chkUpgraded.Value = True Or chkAverage = True Then
    chkAverage.Value = False
    chkSuperior.Value = False
    chkUpgraded.Value = False
    chkBasic.Value = True
  End If
End Sub
Private Sub chkInterior_Click( )
  If (chkSelf.Value = True) Then
    chkSelf.Value = False
    chkInterior.Value = True
  End If
End Sub
Private Sub chkPrimary_Click( )
  If (chkSecondary.Value = True) Then
    chkSecondary.Value = False
    chkPrimary.Value = True
  End If
End Sub
Private Sub chkRenovated_Click( )
    If (chkRenovated.Value = True) Then
    txtYearR.Visible = True
    lblRenov.Visible = True
  Else
    txtYearR.Visible = False
    lblRenov.Visible = False
  End If
End Sub
Private Sub chkSecondary_Click( )
  If (chkPrimary.Value = True) Then
    chkPrimary.Value = False
    chkSecondary.Value = True
  End If
End Sub
Private Sub chkSelf_Click( )
  If (chkInterior.Value = True) Then
    chkInterior.Value = False
    chkSelf.Value = True
  End If
End Sub
Private Sub chkSuperior_Click( )
  If (chkUpgraded.Value = True) Or chkBasic.Value = True Or chkAverage = True Then
    chkBasic.Value = False
    chkAverage.Value = False
    chkUpgraded.Value = False
    chkSuperior.Value = True
  End If
End Sub
Private Sub chkTerrace_Click( )
  If (chkTerrace.Value = True) Then
    txtTer.Visible = True
    lblTer.Visible = True
  Else
    txtTer.Visible = False
    lblTer.Visible = False
  End If
End Sub
Function Validate( )
  If (txtLA.Value = ”” Or txtYear = ””) Then
    Validate = False
  Else
    Validate = True
  End If
End Function
Private Sub ComboBox2_Change( )
End Sub
Private Sub chkUpgraded_Click( )
  If (chkSuperior.Value = True) Or chkBasic.Value = True Or chkAverage = True Then
  chkSuperior.Value = False
  chkBasic.Value = False
  chkAverage.Value = False
  chkUpgraded.Value = True
  End If
End Sub
Private Sub CommandButton1_Click( )
  Dim LivingArea, TerraceArea, YearBuilt, YearRenovated, useYear As Integer
  Dim A_and_A, ContentsMin, TerraceCost, costPerFt, total As Integer ‘subtotals for rc
  Dim ContentsCost As Double
  Dim Condition As String
  Dim Contents_Per As Double
  Now we declare the variables
  ‘*******************************
  If Validate( ) = False Then
    MsgBox ”Please fill out at a minimum the total living area and year built. Thank you.”, vbOKOnly
    Exit Sub
  End If
  LivingArea = txtLA.Value
```

| | |
|---|---|
| If chkTerrace = True Then | ‘only count the terrace if terrace is checked |

TerraceArea = txtTer.Value

| | |
|---|---|
| Else | ‘ otherwise assign a value of 0 |

```
    TerraceArea = 0
  End If
  YearBuilt = txtYear.Value
  If chkRenovated = True Then
    YearRenovated = txtYearR.Value
  Else
    YearRenovated = 0
  End If
  If YearBuilt > YearRenovated Then
    useYear = YearBuilt
  Else
    useYear = YearRenovated
  End If
  If (chkPrimary = True And chkInterior = True) Then ‘ If this is a primary
    Condition = ”Excellent” ‘residence and interior dec was used
```

| | |
|---|---|
| Contents_Per = 0.5 | ‘50% of AA |

```
  ElseIf (chkPrimary = True And chkInterior = False) Then
    Condition = ”Above”
```

| | |
|---|---|
| Contents_Per = 0.4 | ‘40% of AA |

```
  ElseIf (chkPrimary = False And chkInterior = True) Then
    Condition = ”Average”
```

| | |
|---|---|
| Contents_Per = 0.35 | ‘35% of AA |

```
  Else
    Condition = ”Average”
```

| | |
|---|---|
| Contents_Per = 0.25 | ‘25% of AA |

```
  End If
  ‘*******************************
  ‘Determine cost per sq ft for living area based on year built/renovated
  ‘*******************************
  Select Case useYear
    Case Is < 1900 ‘pre 1900 condo
      Select Case Condition
        Case ”Excellent”
          costPerFt = 680
        Case ”Above”
          costPerFt = 425
        Case ”Average”
          costPerFt = 350
      End Select
    Case 1900 To 1944 ‘ pre 1945
      Select Case Condition
        Case ”Excellent”
          costPerFt = 600
        Case ”Above”
          costPerFt = 375
        Case ”Average”
          costPerFt = 320
      End Select
    Case Else ‘post 1944
      Select Case Condition
        Case ”Excellent”
          costPerFt = 500
        Case ”Above”
          costPerFt = 350
        Case ”Average”
          costPerFt = 300
      End Select
  End Select
    A_and_A = LivingArea * costPerFt
    ContentsMin = A_and_A * 0.15
    TerraceCost = TerraceArea * 50 ‘$50 per sq ft for terraces
    Dim quality As Integer
    If (chkBasic.Value = True) Then
    quality = 1
    ElseIf (chkAverage.Value = True) Then
    quality = 2
    ElseIf (chkUpgraded.Value = True) Then
    quality = 3
  Else
    quality = 4
  End If
  lblMin.Visible = False
  ContentsCost = cost(1, quality) * CDbl(cmbLiving.Value) + cost(2,
  quality) * CDbl(IIf(cmbFoyer.Value = ””, 0, (cmbFoyer.Value)
  If ContentsCost < ContentsMin Then
    ContentsCost = ContentsMin
    lblMin.Visible = True
  End If
    txtAA.Value = Format(A_and_A, ”$#,###”)
    txtContents.Value = Format(ContentsCost, ”$#,###”)
    txtTerrace.Value = Format(TerraceCost, ”$#,###”)
    txtRC.Value = Format((A_and_A + ContentsCost + TerraceCost), ”$#,###”)
    ‘Put data on current excel sheet
    Dim x As Integer
  x = 1
  ActiveWorkbook.Sheets(1).Select
  ActiveSheet.Unprotect (”timcondotool”)
  Range(Cells(500, 1), Cells(500, 50)).ClearContents
  With ActiveSheet
    Cells(499, x) = ”Name of Insured”
    Cells(500, x) = txtInsured
    x = x + 1
    Cells(499, x) = ”Address”
    Cells(500, x) = txtAddress
    x = x + 1
    Cells(499, x) = ”Zip”
    Cells(500, x) = txtZip
    x = x + 1
    Cells(499, x) = ”Primary Residence”
    Cells(500, x) = chkPrimary
    x = x + 1
    Cells(499, x) = ”Interior Decorator Used”
    Cells(500, x) = chkInterior
    x = x + 1
    Cells(499, x) = ”Living Area (SQ FT)”
    Cells(500, x) = txtLA
    x = x + 1
    If (chkTerrace = True) Then
      Cells(499, x) = ”Terrace Area (SQ FT)”
      Cells(500, x) = txtTer
      x = x + 1
    Else
      Cells(499, x) = ”Terrace Area (SQ FT)”
      x = x + 1
    End If
    Cells(499, x) = ”Year Built”
    Cells(500, x) = txtYear
    x = x + 1
    If (chkRenovated = True) Then
      Cells(499, x) = ”Year Renovated”
      Cells(500, x) = txtYearR
      x = x + 1
    Else
      Cells(499, x) = ”Year Renovated”
      x = x + 1
    End If
    Cells(499, x) = ”A&A”
    Cells(500, x) = txtAA
    x = x + 1
    Cells(499, x) = ”Contents”
    Cells(500, x) = txtContents
    x = x + 1
    Cells(499, x) = ”Terraces”
    Cells(500, x) = txtTerrace
    x = x + 1
    Cells(499, x) = ”Total Replacement Cost”
    Cells(500, x) = txtRC
    x = x + 1
    Cells(499, x) = ”Date Calculated”
    Cells(500, x) = Now
    ‘ Range(Cells(499, 1), Cells(500, x)).Columns.AutoFit
  End With
  ActiveSheet.Protect Password:=”timcondotool”, AllowFormattingColumns:=True,
  AllowFormattingRows:=True, AllowInsertingRows:=Tr [symbol]
End sub
Private Sub CommandButton2_Click( )
  ‘ Copy contents to clipboard.
  Dim x As Integer
  x = 1
  CommandButton1_Click
  ActiveWorkbook.Sheets(1).Select
  Range(Cells(499, 1), Cells(500, 50)).Copy
End Sub
Function SendToClipBoard(AnyValue As Variant) As Boolean
Dim DatObj As DataObject
On Error GoTo Handler
Set DatObj = New DataObject
With DatObj
  .SetText CStr(AnyValue), 1
  .PutInClipboard
End With
SendToClipBoard = True
Exit Function
Handler:
SendToClipBoard = False
End Function
Private Sub CommandButton3_Click( )
  ‘Save data on the All Previous sheet.
  CommandButton1_Click
  ActiveWorkbook.Sheets(1).Select
  ActiveSheet.Unprotect (”timcondotool”)
  ActiveWorkbook.Sheets(2).Select
  ActiveSheet.Unprotect (”timcondotool”)
  ActiveWorkbook.Sheets(1).Select
  Range(Cells(500, 1), Cells(500, 50)).Copy
  ActiveWorkbook.Sheets(2).Select
  With ActiveSheet
    .Range(Cells(3, 1), Cells(3, 50)).Insert shift:=xlDown
  End With
  With ActiveSheet
    .Range(Cells(3, 1), Cells(3, 50)).Locked = False
  End With
  ActiveWorkbook.Sheets(1).Select
  Range(Cells(500, 1), Cells(500, 50)).ClearContents
  ActiveWorkbook.Sheets(1).Select
  ActiveSheet.Protect Password:=”timcondotool”, AllowFormattingColumns:=True,
  AllowFormattingRows:=True, AllowInsertingRows:=Tr [symbol]
  ActiveWorkbook.Sheets(2).Select
  ActiveSheet.Protect Password:=”timcondotool”, AllowFormattingColumns:=True,
  AllowFormattingRows:=True, AllowInsertingRows:=Tr [symbol]
End Sub
Private Sub CommandButton4_Click( )
  If (txtLA <> ””) And (txtYear <> ””) Then
    MultiPage1.Pages(1).Visible = True
    MultiPage1.Value = 1
    Else
    MsgBox ”Please fill in the A&A form.”, vbOKOnly, ”Finish”
  End If
End Sub
Private Sub CommandButton5_Click( )
  If (cmbLiving.Value <> ””) And (cmbBed.Value <> ””)
  And (cmbBath.Value <> ””) And (cmbKitchen.Value <> ””) Then
    MultiPage1.Pages(2).Visible = True
    MultiPage1.Value = 2
    CommandButton1_Click
  Else
    MsgBox ”Please complete the form before moving on.”, vbOKOnly, ”Finish”
  End If
End Sub
Private Sub MultiPage1_Change( )
End Sub
Private Sub UserForm_Initialize( )
  ‘Lists for drop downs for the rooms this one has the option of 0
  myRooms0(1) = 0
  myRooms0(2) = 1
  myRooms0(3) = 2
  myRooms0(4) = 3
  myRooms0(5) = 4
  myRooms0(6) = 5
  myRooms0(7) = 6
  ‘Lists for drop downs for the rooms this one has the option of only higher than 1
  myRooms1(1) = 1
  myRooms1(2) = 2
  myRooms1(3) = 3
  myRooms1(4) = 4
  myRooms1(5) = 5
  myRooms1(6) = 6
  ‘Assign lists to drop downs
  cmbLiving.List = myRooms1
  cmbFoyer.List = myRooms0
  cmbDining.List = myRooms0
  cmbLib.List = myRooms0
  cmbBed.List = myRooms1
  cmbBath.List = myRooms1
  cmbKitchen.List = myRooms1
  ‘Define the pricing matrix.
  ‘Done for Medium size accross the board for all rooms
  ‘Living Room
  cost(1, 1) = 40000 ‘Basic
  cost(1, 2) = 45200 ‘Average
  cost(1, 3) = 100000 ‘Upgraded
  cost(1, 4) = 191500 ‘Superior
  ‘Foyer
  cost(2, 1) = 6141 ‘Basic
  coat(2, 2) = 7700 ‘Average
  cost(2, 3) = 18500 ‘Upgraded
  cost(2, 4) = 37000 ‘Superior
  ‘Dining Room
  cost(3, 1) = 39468 ‘Basic
  cost(3, 2) = 48400 ‘Average
  cost(3, 3) = 112300 ‘Upgraded
  cost(3, 4) = 214100 ‘Superior
  ‘Library
  cost(4, 1) = 65000 ‘Basic
  cost(4, 2) = 76700 ‘Average
  cost(4, 3) = 160000 ‘Upgraded
  cost(4, 4) = 304500 ‘Superior
  ‘Bedroom
  cost(5, 1) = 30000 ‘Basic
  cost(5, 2) = 37250 ‘Average
  cost(5, 3) = 79750 ‘Upgraded
  cost(5, 4) = 145500 ‘Superior
‘Bathroom
  cost(6, 1) = 2415 ‘Basic
  cost(6, 2) = 3500 ‘Average
  cost(6, 3) = 8500 ‘Upgraded
  cost(6, 4) = 18000 ‘Superior
  ‘Kitchen
  cost(7, 1) = 13000 ‘Basic
  cost(7, 2) = 19300 ‘Average
  cost(7, 3) = 30550 ‘Upgraded
  cost(7, 4) = 43800 ‘Superior
  ‘Men's wardrobe
  cost(8, 1) = 25000 ‘Basic
  cost(8, 2) = 39000 ‘Average
  cost(8, 3) = 76150 ‘Upgraded
  cost(8, 4) = 159200 ‘Superior
  ‘Woman's wardrobe
  cost(9, 1) = 60000 ‘Basic
  cost(9, 2) = 70575 ‘Average
  cost(9, 3) = 148650 ‘Upgraded
  cost(9, 4) = 305000 ‘Superior
End Sub [symbol]
indicates data missing or illegible when filed
```

What is claimed is:

1. A method for calculating an estimated replacement cost of a home to provide initial insurance coverage for the home, the method comprising:
receiving a request to access a home value estimator software application from a user;
displaying a user interface of the home value estimator software application across a communication network to the user;
receiving data pertaining to different characteristics of a customer's home from the user interface of the home value estimator software application;
accessing replacement costs of the different characteristics of the customer's home from at least one matrix stored in a replacement cost database based on a set of criteria;
calculating an estimated replacement cost of the customer's home from the replacement costs of the different characteristics of the customer's home; and
generating an initial insurance premium and the initial insurance coverage using the home value estimator software application for the user.

2. The method according to claim 1, wherein the different characteristics are selected from the group consisting of physical attributes of the home, home renovations, additions, alterations, home contents, home furnishings, and clothing wardrobes.

3. The method according to claim 1, wherein the set of criteria comprises of the quantity of different characteristics of the customer's home and the quality of different characteristics of the customer's home.

4. The method according to claim 1, further comprising:
receiving a request from the user for a non-bindable coverage number and a non-bindable insurance premium by an insurance company; and
receiving a request from the user for a bindable coverage number and a bindable insurance premium by the insurance company.

5. The method according to claim 1, further comprising:
generating the estimated replacement cost of the customer's home by adding the replacement costs of the different characteristics of the customer's home;
determining a loss frequency rate for a home insurance product;
determining a target loss ratio for the home insurance product;
determining the initial insurance coverage based on the estimated replacement cost of the customer's home; and
calculating the initial premium by multiplying the estimated replacement cost of the customer's home by the loss frequency rate and then dividing by the target loss ratio.

6. The method according to claim 1, further comprising providing an insurance policy to the customer based on the initial insurance premium and the initial insurance coverage given by the home value estimator software application.

7. The method according to claim 1, further comprising adjusting the initial insurance premium and the initial insurance coverage based on the appraisal value of the customer's home in the inspection report and updating the insurance policy to reflect a change in the insurance premium and the insurance coverage due to the appraisal value of the customer's home in the home inspection report.

8. The method according to claim 1, wherein the home value estimator software application is a spreadsheet software application.

9. The method according to claim 1, further comprising:
determining a replacement cost per square foot of a characteristic of the customer's home;
calculating a replacement cost of the characteristic of the customer's home by multiplying the replacement cost per square foot for the characteristic of the customer's home by a square footage of the characteristic.

10. The method according to claim 1, further comprising:
determining a threshold of a first characteristic of the customer's home to select between two sets of replacement costs for a second characteristic of the customer's home;
determining the first characteristic of the customer's home based on the user input data pertaining to the different characteristics of the customer's home;
comparing the first characteristic of the customer's home to the threshold;
selecting a replacement cost from the first set of replacement costs for the second characteristic of the home when the first characteristic of the customer's home exceeds the threshold; and
selecting a replacement cost from the second set of replacement costs for the second characteristic of the home when the first characteristic of the customer's home does not exceed the threshold.

11. A system for calculating an estimated replacement cost of a home to provide an initial insurance coverage for the home, the system comprising:
a user interface responsive to user input, wherein the user interface transmits and receives data pertaining to different characteristics of a customer's home between a user and a home value estimator software application;
a replacement cost database capable of storing at least one matrix containing replacement cost data of different characteristics of the home;
a server capable of transmitting and receiving data pertaining to the different characteristics of the customer's home and replacement costs of said characteristics of the customer's home, over the communication network; and
the home value estimator software application, running on the server that calculates the replacement cost of the customer's home by determining replacement costs for individual characteristics associated with the home and then summing each of the individual characteristic replacements costs.

12. The system according to claim 11, wherein the different characteristics are selected from the group consisting of physical attributes of the home, home renovations, additions, alterations, home contents, home furnishings, and clothing wardrobes.

13. The system according to claim 11, wherein the set of criteria comprises of the quantity of different characteristics of the home and the quality of different characteristics of the home.

14. The system according to claim 11, wherein the home value estimator software application is a spreadsheet software application.

15. A method for estimating a replacement cost of a home to provide an initial insurance coverage for the home, the method comprising:
collecting replacement cost data for different characteristics of the home using a heuristic research methodology and storing the replacement cost data in a research database;
analyzing the replacement cost data for the different characteristics of the home using analytical software tools and organizing replacement costs of different characteristics of the home into a set of categories based on a set of criteria using a heuristic categorizing methodology;
storing the set of categories of replacement costs for different characteristics of the home in at least one matrix; and
accessing a replacement cost from at least one matrix stored in the replacement cost database by a home value estimator software application; and
estimating a total replacement cost of the home by adding each replacement cost of each different characteristic that is applicable to the home.

16. The method according to claim 15, wherein the different characteristics are selected from the group consisting of physical attributes of the home, home renovations, additions, alterations, home contents, home furnishings, and clothing wardrobes.

17. The method according to claim 15, wherein the set of criteria comprises of the quantity of different characteristics of the home and the quality of different characteristics of the home.

18. The method according to claim 15, wherein the replacement cost data for the different characteristics of the home is selected from the group consisting of home inspection reports, claim adjustment reports, submitted claims, price lists, and invoices.

19. The method according to claim 15, further comprising updating the replacement cost data for the different characteristics of the home at regular intervals and updating the replacement costs in the at least one matrix stored in the replacement cost database at the regular intervals using the analytical software tools.
